(19) United States
(12) Patent Application Publication
(10) Pub. No.: US 2019/0102977 A1
(43) Pub. Date: Apr. 4, 2019

(54) GAMING MACHINE AND METHOD HAVING BONUS FEATURES WITH PROGRESSIVE WIN OPTIONS

(71) Applicant: Everi Games, Inc., Austin, TX (US)

(72) Inventors: Marshall Adair, Austin, TX (US); Brian Watkins, Austin, TX (US)

(73) Assignee: Everi Games, Inc., Austin, TX (US)

(21) Appl. No.: 15/878,037

(22) Filed: Jan. 23, 2018

Related U.S. Application Data
(60) Provisional application No. 62/566,515, filed on Oct. 1, 2017.

(51) Int. Cl. G07F 17/32; G07F 17/34

(52) U.S. Cl. CPC G07F 17/3213; G07F 17/34; G07F 17/3267; G07F 17/3258

(57) ABSTRACT

A gaming machine and method for providing slot machine game having a bonus round in which player interactions select a progressive prize to be awarded. The bonus round is entered based on a graphical accumulator object which persists between rounds of the base wagering game. Triggering events fill up the object and eventually trigger a bonus round in which a progressive is awarded. Player selections of player interactive bonus objects in the bonus round reveal progressive prize symbols or progressive eliminator symbols. The eliminator symbols cause removal of the currently lowest value progressive prize from the group of available progressive prizes. Obtaining a matching set of progressive prize symbols awards the associated progressive prize. Data structures and executable program code design are provided for implementing the methods and programming a special purpose gaming machine.

### CROSS-REFERENCE TO RELATED APPLICATIONS

This application claims the benefit of U.S. Provisional Application No. 62/566,515, filed Oct. 1, 2017, titled “Gaming Machine and Method Having Bonus Features With Progressive Win Options” which application is hereby incorporated by reference for all purposes.

### FIELD OF THE INVENTION

This invention relates to gaming systems and to gaming machines through which players may participate in wagering games, and in particular to a bonus round providing ways to win progressive prizes.

### BACKGROUND

Many different types of gaming machines have been developed to provide various formats and graphic presentations for conducting games and presenting game results. For example, numerous mechanical reel-type gaming machines, also known as slot machines, have been developed with different reel configurations, reel symbols, and paylines. More recently, gaming machines have been developed with video monitors that are used to produce simulations of mechanical spinning reels. These video-based gaming machines may use one or more video monitors to provide a wide variety of graphic effects in addition to simulated spinning reels, and may also provide secondary/bonus games using different reel arrangements or entirely different graphics. Many video-based gaming machines have three or five spinning reels that may be stopped to display a matrix of game symbols. The symbols displayed on the stopped reels correlate to a result of the game. Video-based gaming machines may also be used to show card games or various types of competitions such as simulated horse races in which wagers may be placed.

Progressive prizes are used in the gaming industry to provide the possibility of winning very large value prizes. The available progressive prizes typically increase over time as a portion of each wager on participating machines is contributed to the progressive prize pool, in return for a chance at winning one of the progressive prizes. In typical existing progressive systems, the progressive is awarded based on a reel-spin result which includes a number of designated symbols in the base game or a bonus game, typically requiring a designated rare symbol to be in every reel of the game, such as five reels requiring five symbols. Multi-level progressives are known in which multiple tiers of prizes are available, which typically include different triggering events in the base or bonus game.

Game manufacturers are continuously pressed to develop new game presentations, formats, and game graphics in an attempt to provide high entertainment value for players and thereby attract and keep players. What is needed are ways to provide both anticipation and excitement to players while providing more variability in game results.

### SUMMARY OF THE INVENTION

The present invention includes wagering games, gaming machines, networked gaming systems that provide improvements to feature games played on slot machines or other gaming machines. A gaming machine and method for providing slot machine game having a bonus round in which player interactions select a progressive prize to be awarded. The bonus round is entered based on a graphical accumulator object which persists between rounds of the base wagering game. Triggering events fill up the object and eventually trigger a bonus round in which a progressive is awarded. Player selections of player interactive bonus objects in the bonus round reveal progressive prize symbols or progressive eliminator symbols. The eliminator symbols cause the removal the currently lowest value progressive prize from the group of available progressive prizes. A graphic sequence shows interaction between the gaming area and the progressive prize symbols to communicate the modification made to the data structures used in the game. Obtaining a matching set of progressive prize symbols awards the associated progressive prize. Data structures and executable program code design are provided for implementing the methods and programming a special purpose gaming machine.

According to another aspect of the invention, a method of providing wagering game operated on a gaming machine employing the data structures and controller process, and awarding resulting prizes.

Another aspect of the invention is a computer program stored on a non-transitory readable medium. The software version is, of course, typically designed to be executed by a gaming machine or networked gaming system. The software includes multiple portions of computer executable code referred to as program code. Gaming results are provided in response to a wager and displayed by display program code that generates simulated slot reels each including one or more symbol locations. The program also has game controller program code for determining game play results involving spins or other randomization of the base and bonus round game presentations.

Another aspect of the invention is a gaming system that includes one or more gaming servers, and a group of electronic gaming machines connected to the servers by a network, programmed to provide one of more of the methods described herein. The various functionality described herein may be distributed between the electronic gaming machines and the gaming servers in any practically functional way. For example, the current preferred architecture is for the servers to determine all aspects of game logic, random number generation, and prize awards. The gaming machines provide functionality of interfacing with the player and animating the game results to present the results received from the server in an entertaining manner. However, other embodiments of course might use a thin client architecture in which the animation is also conducted by the server and electronic gaming machines serve merely as a terminal to receive button or touchscreen input from the player and to display graphics received from the server.

Different features may be included in different versions of the invention. These and other advantages and features of the invention will be apparent from the following description of the preferred embodiments, considered along with the accompanying drawings.

### BRIEF DESCRIPTION OF THE DRAWINGS

FIG. 1 is a game screen diagram showing a base game mode having multiple game presentations according to an example embodiment.

FIGS. 2A-2C are a sequence of bonus round screen diagrams according to an example embodiment.

FIG. 3 is a flowchart of a process for providing a base game according to an example embodiment.

FIG. 4 is a flowchart of a process for providing a bonus game according to an example embodiment.

FIG. 5 is a front perspective view of a gaming machine which may be used in a gaming system of the present invention.

FIG. 6 is a block diagram showing various electronic components of the gaming machine shown in FIG. 5 together with additional gaming system components.

FIG. 7 is a system block diagram of a gaming system according to one embodiment of the present invention.

FIGS. 8-15 are a sequence of screenshot images showing the progression of a bonus feature according to an example embodiment.

### DETAILED DESCRIPTION OF EXAMPLE EMBODIMENTS

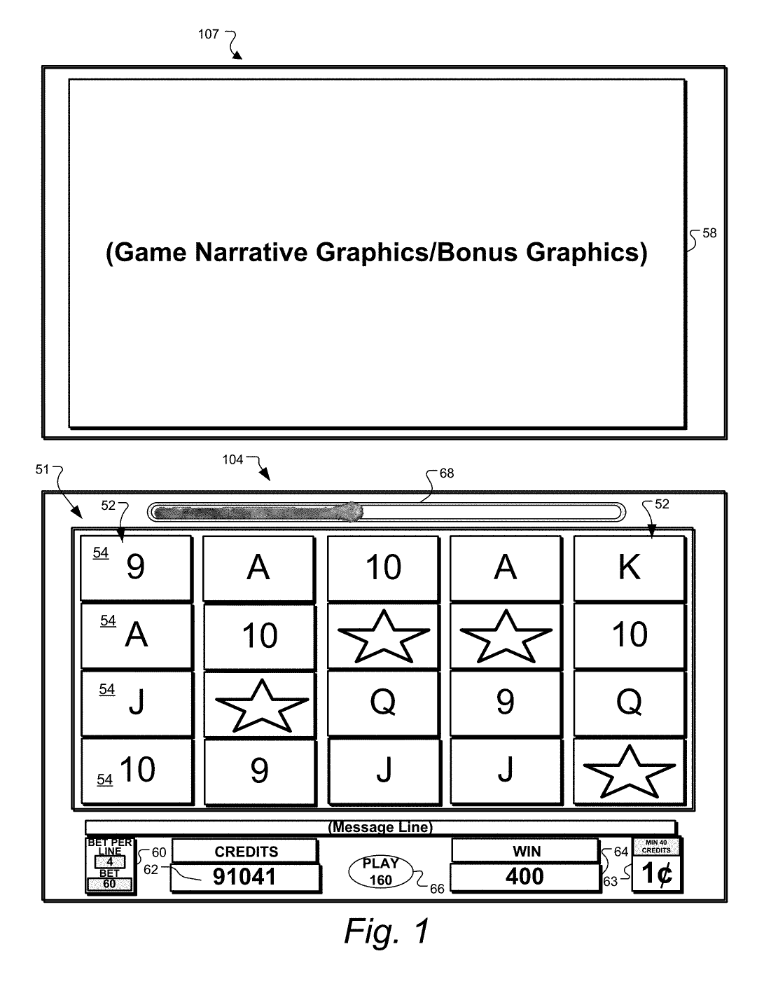

FIG. 1 is a game screen diagram illustrating a base game mode showing the primary display 104 and secondary (top) display 107 to illustrate an example slot machine display arrangement on which wagering game results are presented in a gaming area, typically found on the primary display. A bonus gaming area 58 is present on the top display, or if a single tall display is used, a bonus gaming area is typically located toward the top of the display and the base game area located toward the bottom of the display. The gaming area of a reel-type primary game (as opposed to bonus games or other feature games as described herein) in this version is a matrix 51 of symbol locations arranged in rows and columns to represent simulated slot machine reels that are spun to conduct a game round. Other embodiments may, of course, use other types of game displays to display randomizing of symbols according to the methods herein. The depicted columns of symbols labeled 52 represent the simulated reels, while symbols are shown in each symbol location designated 54. In this instance there are five reels with four symbol locations 54 displayed at a time on each reel, but the game can be played with more and less reels. The simulated reel typically has far more symbols than those displayed, and as many unique stop positions as there are symbols on the simulated reel. The stop position may be counted, for example, by numbering the symbols on the simulated reel and using the number of the symbol at the bottom of the display window (the three symbols displayed in this example), or at the top or middle. Further, while multi-symbol reels are shown, other versions may use simulated uni-symbol reels, or a reel that has many symbols thereon but only a single window to the reel simulated, displaying a single symbol from the reel. Some variations of the present invention may use a simulated uni-symbol reel in each depicted symbol location 54. Winning patterns are typically formed by matching symbols along defined paylines that pass through the matrix 51.

Above the matrix 51 is a graphical accumulator object 68, which has a persistent state across multiple rounds of the base game as further described below, and increases its accumulation level in response to designated symbols appearing in a base game result. If the accumulator object 68 is filled, a progressive bonus round results.

Below matrix 51 is box 60, which displays the current wager and amount bet per payline. Other versions may not have a designated bet per line. To the right of box 60 is box 62, which displays the current credits in the player's account. In the bottom center a touchscreen play button 66 is presented in the lower central area of the display, which may show other game state related graphics. Right of this is win box 64, which displays the player's last awarded winnings. The wager credit denomination is shown in box 63. Along the bottom edge of the matrix 51 there is a message line, where the game station can display further instructions to the player.

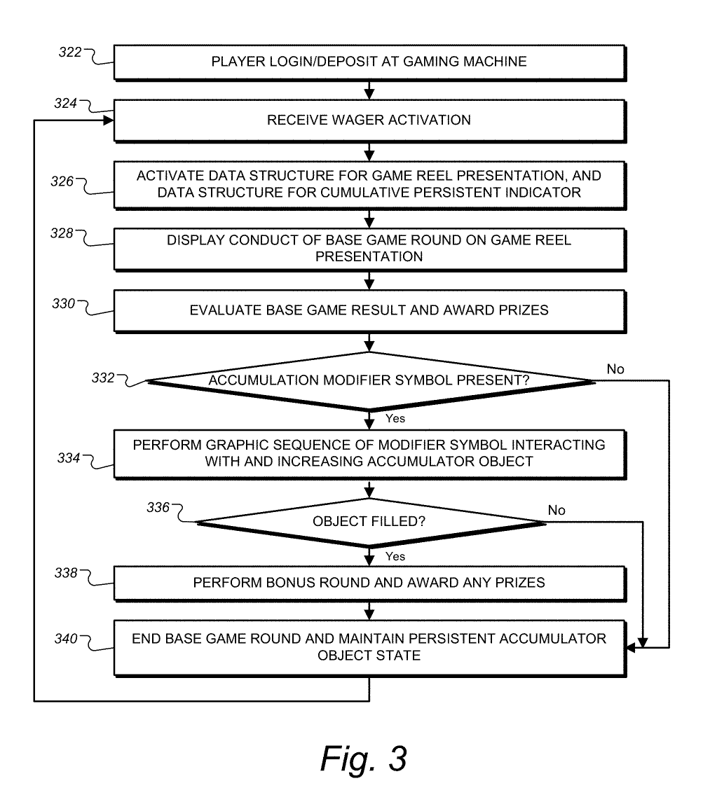

FIG. 3 is a flowchart showing a process for providing a wagering game base game according to one or more embodiments of the invention. Generally, the process is conducted under control of one or more electronic processors to present gaming results on one or more displays on a gaming machine such as those described below. To initialize the game and make it available for wagering, the process starts a game engine software package for executing the game, and provides several data structures which are manipulated to conduct the game, including: a first data structure stored in a memory of the gaming machine comprising data corresponding to a reel-type game presentations including a set of virtual reel strips including game symbols, second and third data structures described with respect to FIG. 3 for use in a bonus game, and providing a fourth a data structure stored in the memory comprising data corresponding to a graphical accumulator object, the fourth data structure having a persistent state across multiple base game rounds. To display the gaming matrix, the process activates the first data structure to cause the game presentation to be displayed by at least one of the displays.

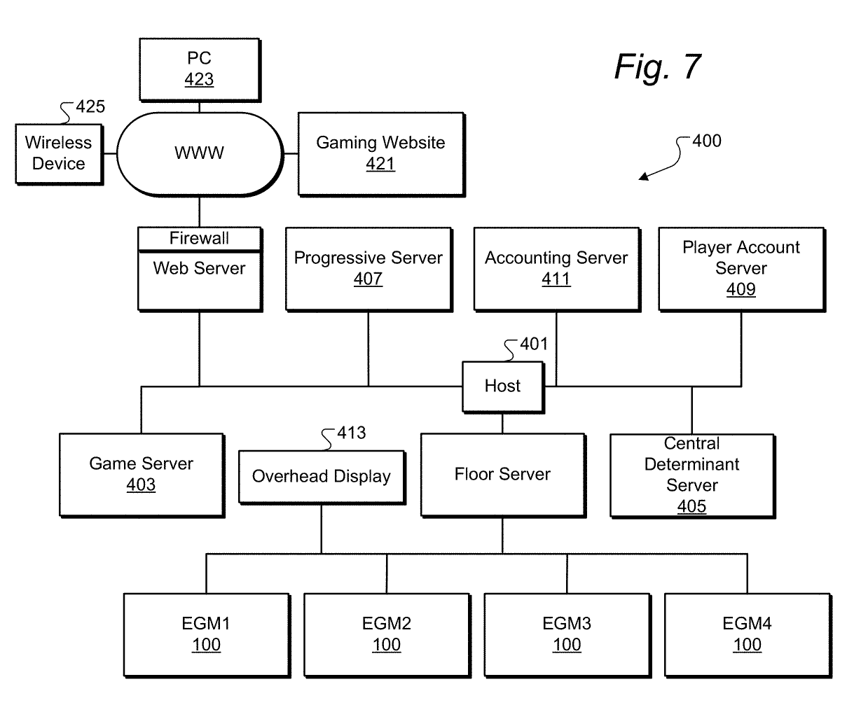

The process of providing a wagering game for a player starts at block 322 where a player logs in or deposits money or a credit voucher at a gaming machine. This includes receiving the player deposit through a credit input device such as the bill/voucher acceptor 112 (FIG. 7), and in response activating a credit meter value that establishes a player credit balance.

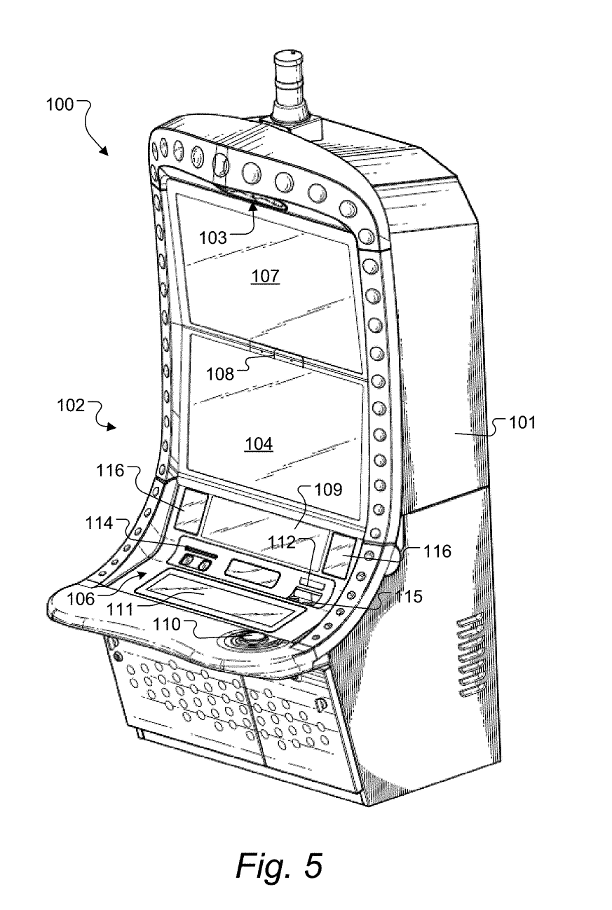

To begin a game play, the method receives a wager activation on a player input device at the gaming machine at block 324, which typically consists of some input from the player to set the amount to be wagered from their credit amount on the machine. The wager amount may also be carried over from previous game rounds by simply starting the game with the previous wager amount set. This typically happens through a ‘Play’ button (110, FIG. 5) on the game cabinet or touchscreen display, and serves to place the wager and start a single round of game play in the base game at block 326. In embodiments having reels, reel displays, or simulated reels, this is conducted by spinning the reels. Other embodiments may otherwise rearrange or randomize the symbols on the matrix in any suitable manner. For games that use other methods of scrambling the matrix besides simulated reels, the random outcome is determined at this step as appropriate for the game. The preferred version generates at least one random number and uses the at least one random number to determine a set of game reel stops, which is fed to a first data structure for providing the game presentation. The base game outcome includes a possibility of winning money value credits and a possibility of winning a bonus game outcome. The game outcome is evaluated at block 330 by checking the symbols on the matrix for winning patterns and other winning symbols or combinations thereof. If a designated accumulation modifier symbol is present, the process at block 332 performs a graphic sequence of the modifier symbol interacting with and increasing the persistent accumulation level of the graphical accumulator object 68. This sequence modifies the fourth data structure to change in memory the accumulation or fill level of the object 68. In a preferred version of the game, the “Hot Stuff” slot machine game by Everi Games, the modifier symbol is shown in the graphic sequence to send a beam or blast of fire at the graphical accumulator object 68, and cause it to increase its depicted heat level or accumulation level. The heat level may be displayed as a meter as depicted in FIG. 1, or as a color or size, or combination thereof, of the graphical accumulator object 68. The graphical accumulator persists in the state it is in at the end of a base game round into the beginning of the next game round. Preferably the persistence lasts until a player cashes out and ends their playing session, or until a bonus game round is achieved. A modification may be provided randomly or based on a target symbol in the base game which lowers the accumulation level of accumulator object 68 during long game play sessions.

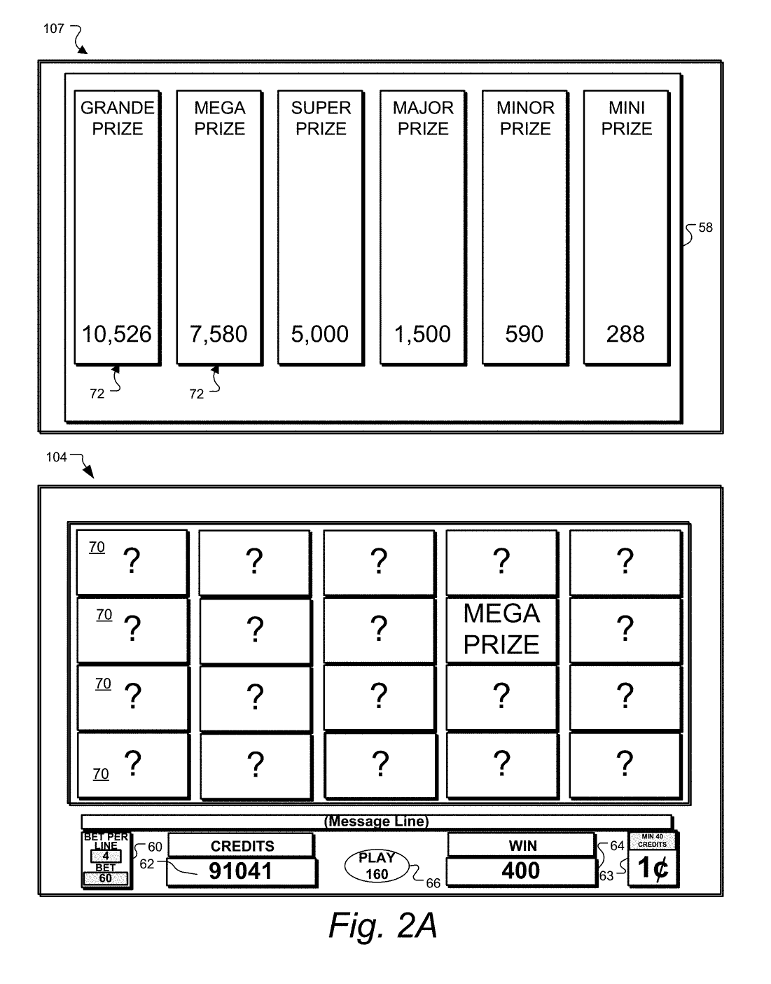

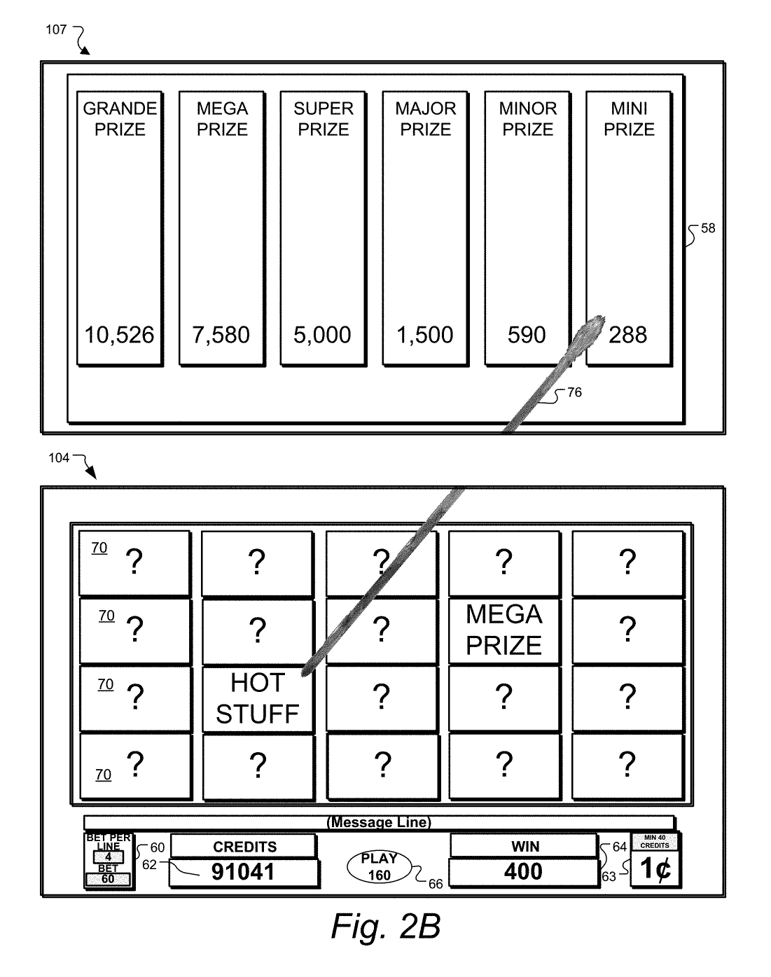

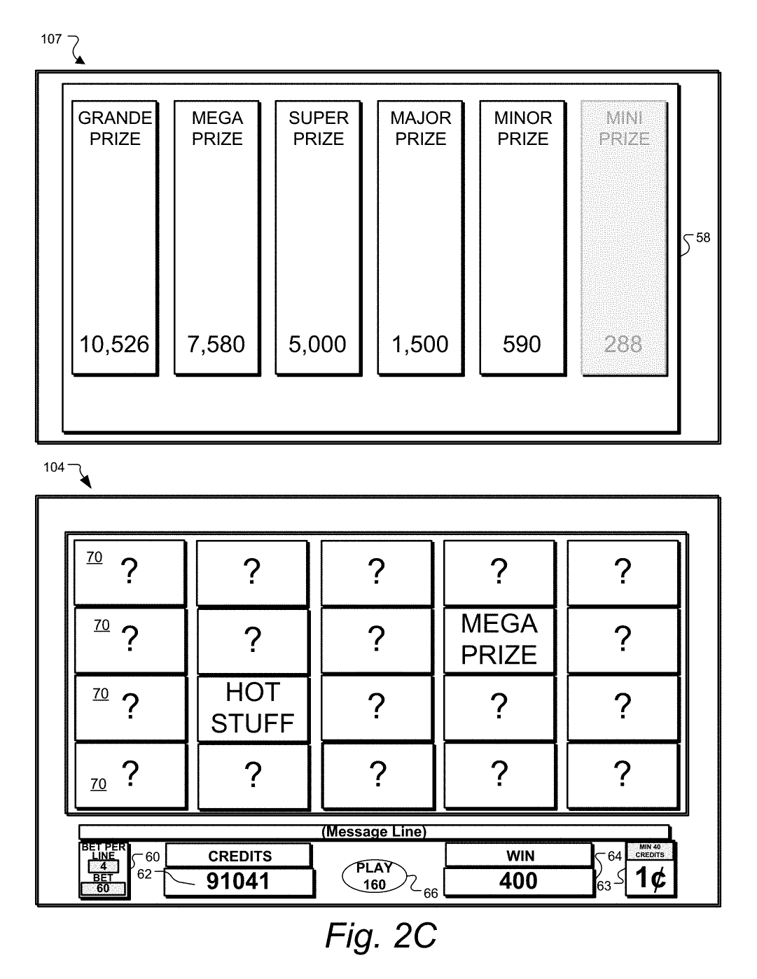

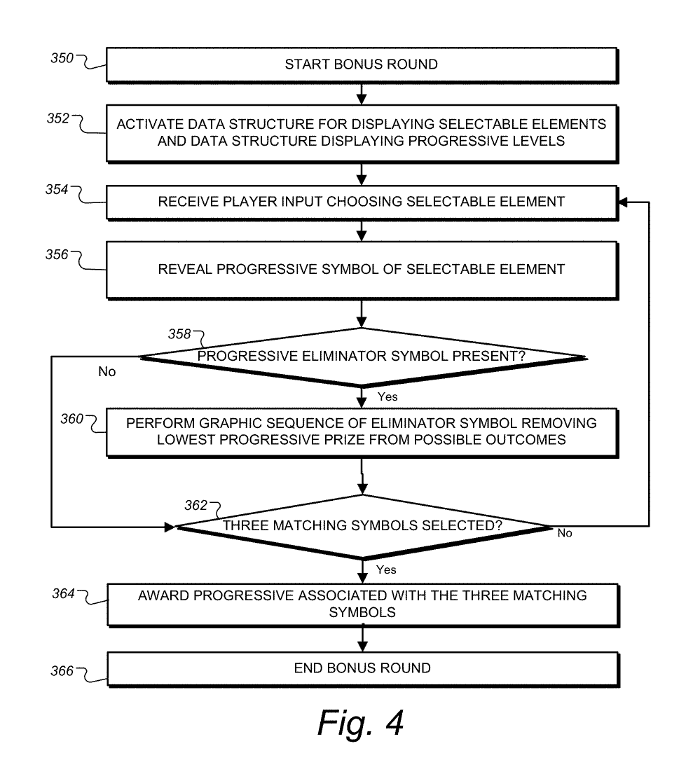

If the accumulator object is filled by the interaction of block 334, the process at block 336 goes to block 338 where it performs a bonus round, preferably the progressive bonus round described with respect to screen diagrams of FIGS. 2A-C and the flowchart of FIG. 4. If the accumulator object 68 is not filled at block 336, the process goes to block 340 where the present base game round is ended and the accumulator object 68 persists in its present fill level to be used for the next base game round.

FIGS. 2A-2C are a sequence of bonus round screen diagrams according to an example embodiment. FIG. 4 is a flowchart of an example process for conducting a progressive bonus round. Already provided by the game initialization process before the bonus game starts are a second data structure stored in the memory comprising data representing a set player interactive bonus objects, and a third data structure stored in the memory comprising data representing graphical indicators of progressive prize awards. The progressive bonus round starts at block 350 as triggered by the process at block 338 of FIG. 3. Next at block 352, the process activates the second data structure and the third data structure to display the conduct of a bonus game and a bonus game result. Data of the third data structure is used to display selectable elements gaming area of display 104, as seen in FIG. 2A, selectable elements 70. Data of the third data structure is used to display graphical objects indicating progressive level prizes available, as shown in the example of FIG. 2A by the six depicted graphical objects 72. At block 354, the process receives a player input choosing a selectable element, and in response at block 356, the chosen player selectable element is changed to reveal a progressive prize symbol having multiple possible types each corresponding to one of the multiple available progressive prizes, or to reveal a progressive eliminator symbol. An example progressive prize symbol is shown in diagram form in FIG. 2A where a selectable element 70 has been selected to reveal “MEGA PRIZE” progressive prize symbol corresponding to the mega prize graphical object 72 shown in secondary display 107. At block 358, the process includes determining if a designated progressive eliminator symbol has been revealed, and if so the process goes to block 360 where it displays a graphical interaction between the progressive eliminator symbol and the graphical indicators, the graphical interaction including showing a lowest value graphical indicator being removed from availability. This is seen in FIG. 2B, which depicts a bonus game screen in which a player has just selected the “HOT STUFF” progressive eliminator symbol, and the graphical interaction is depicted by an animated beam of fire 76 emerging from the HOT STUFF symbol and passing to the lowest value progressive prize graphical indicator displayed, the “MINI PRIZE” indicator. The animation of the graphic sequence preferably shows the indicator burning up. Along with this, the process removes the lowest value progressive prize from the remaining selectable elements and the group of available progressive prizes in memory of the third data structure. The indicator preferably remains on the screen, greyed-out as depicted in FIG. 2C, and may include a depiction of ashes or other indication it has been burned or removed.

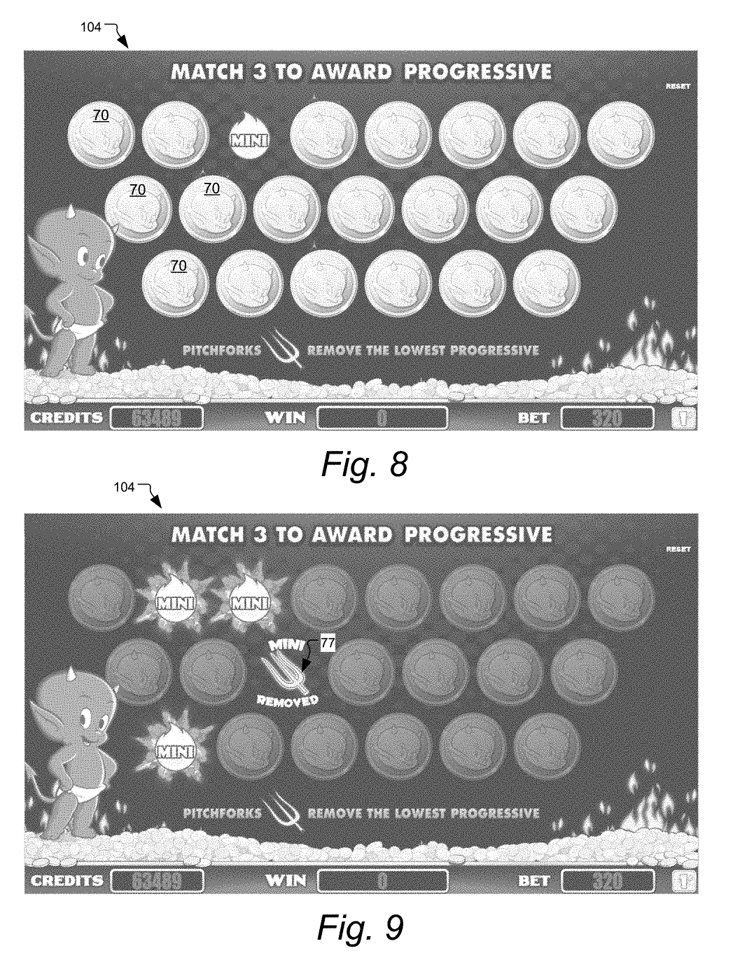

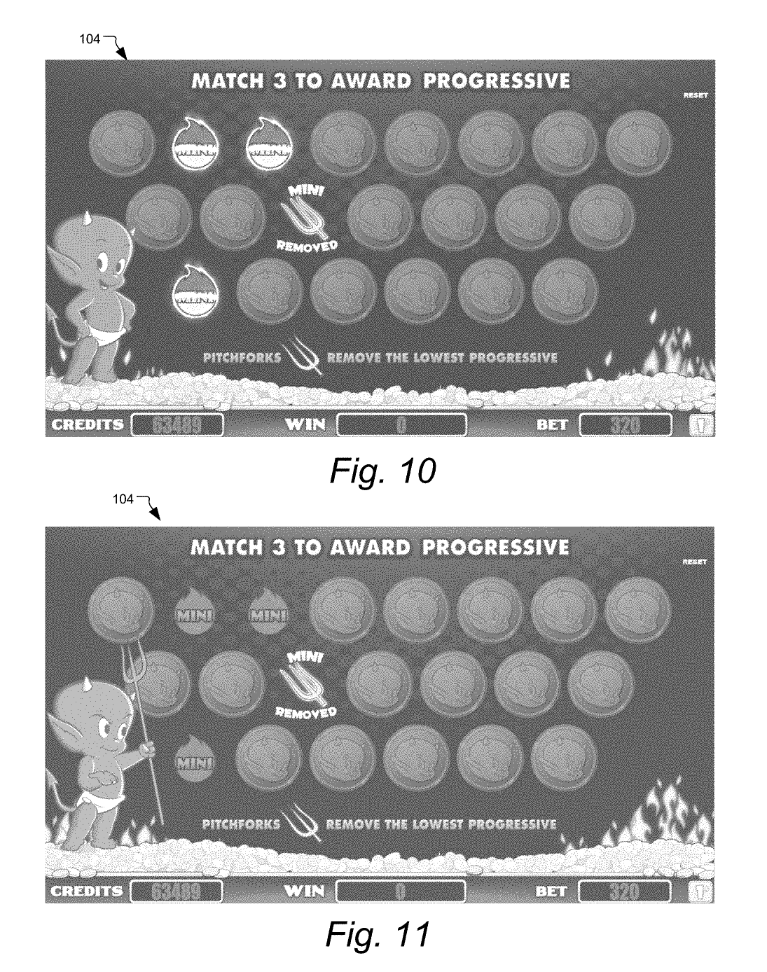

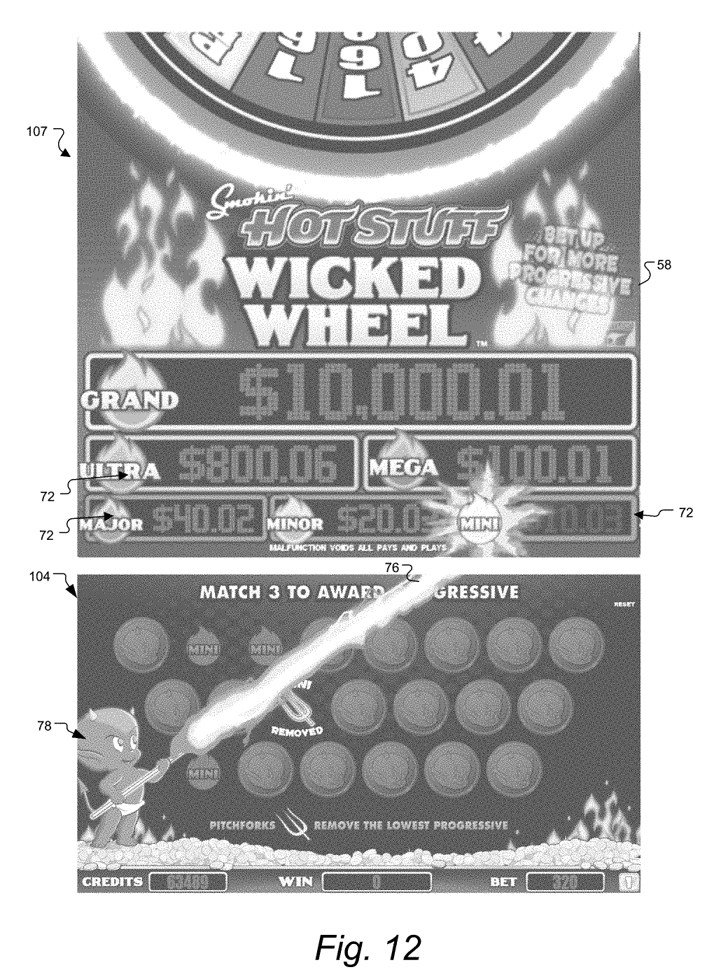

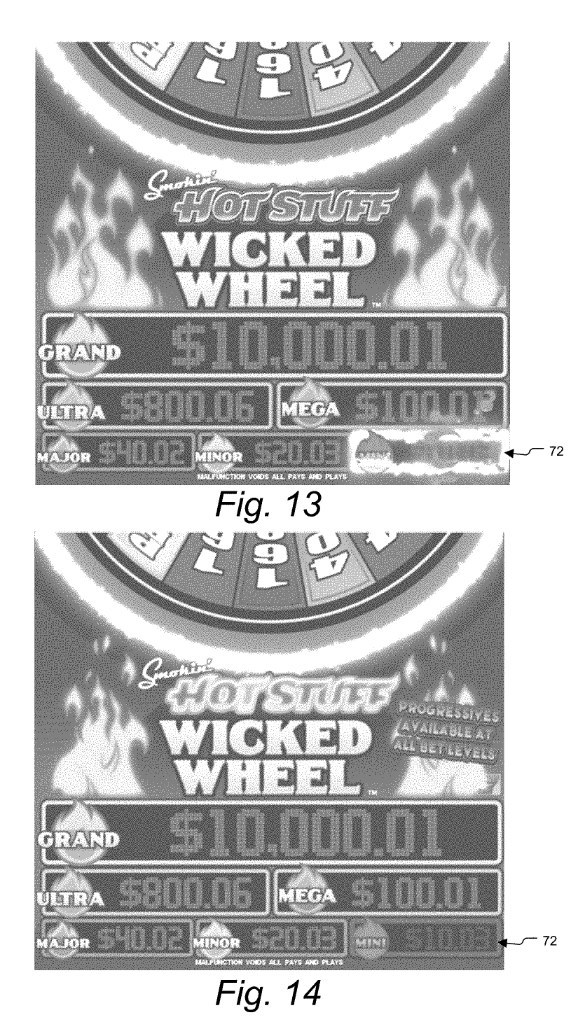

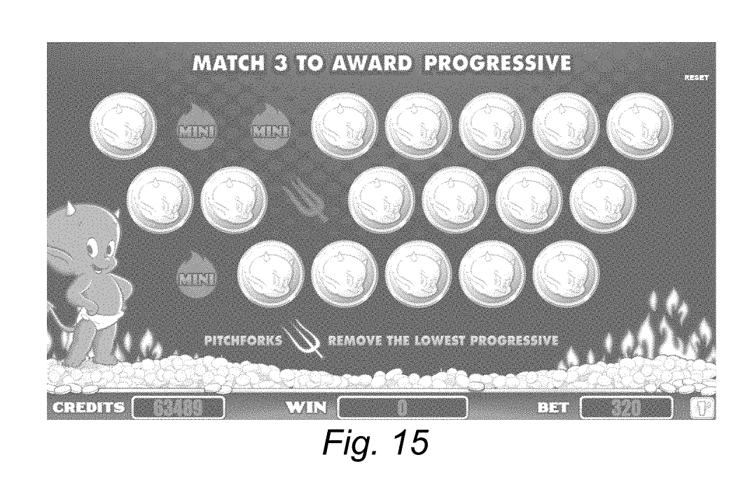

Another example embodiment with such a bonus feature is found in the sequence of screenshots of FIGS. 8-15. FIG. 8 shows an example bonus game screen, which in this version replaces the base game graphics during the bonus round, and is displayed on the primary display 104. At the point shown in FIG. 8, a player has made a first selection of a selectable element 70 which uncovered a “Mini” prize indicator element which may be accumulated in the game to win the mini progressive prize. The selection is typically made through touching the selected element on a touchscreen display of the gaming machine. The results of the player's next selection are shown in FIG. 9, where the “Pitchfork” symbol 77 is uncovered, which is a progressive eliminator symbol having similar function to the “Hot Stuff” symbol in the previous embodiment. The “Pitchfork” selection starts a graphic sequence which modifies the state of the game's second data structure (stored in the memory) including data representing a set of player interactive bonus objects by changing the state of the other two hidden “Mini” prize indicator symbols to be unhidden. Next, as shown in the screenshot of FIG. 10, all three of the “Mini” are animated to show them burning out or becoming grayed out, with the result of this animation shown in FIG. 11. This communicates to the player that the symbols have been removed from possible selection in the array of selectable items. Next in the sequence, FIG. 12 shows the primary display 104 and the secondary display 107 including display area 58 (note that the two display areas may be together on the same display in some versions). Depicted is an animated sequence immediately following that of FIG. 11, showing the toddler “devil” character using a fires-shooting pitchfork to eliminate the “Mini” progressive prize indicator 72 from the available options. More generally the process modifies the third data structure stored in the memory including data representing graphical prize indicator 72 (one of the group of indicators 72 of different progressive prize awards), by changing the state of the modified indicator 72 to be unavailable in the present bonus game round. Preferably this is accomplished with a graphis sequence showing interaction between one or more elements the first display area in display 104 and display area 58, such as the depicted beam of fire coming from the toddler devil's pitchfork. This includes changing the graphical state of the modified indicator 72 after showing it being burned or otherwise modified in the depicted graphic sequence, as shown in the sequence of FIGS. 13-14, with FIG. 13 showing the prize indicator 72 being modified (burned) and FIG. 14 showing the final state with the prize indicator 72 grayed out to communicate that it is no longer available to be won. FIG. 15 then shows the state of the set of player interactive bonus objects ready for the next player selection.

At block 358, the process includes determining if a designated set, such as three, matching progressive prize symbols have been revealed, and if so awarding a corresponding progressive prize at block 364. Then the bonus round ends at block 366. Preferably if the bonus round starts, the player picks continue until a progressive prize is awarded; however in some versions the number of picks may be limited, providing the possibility of leaving the bonus round with no progressive prize.

Referring to FIG. 3 and FIG. 4, the process functionality is controlled by the system processor by executing program code, executable by a gaming machine or gaming network processor, to accomplish the functionality as described herein. It should be understood that this is only one example embodiment, and other versions may divide the processing tasks of the game method in a different manner. For example, some systems may employ a thin client architecture in which practically all of the processing tasks are performed at the game server, and only display information for the player interface transmitted to the electronic gaming machine. In such an embodiment, only the steps involving player input or display are performed by the electronic gaming machine, with the remaining steps performed by one of the game servers in the system. In such a case, though, the software architecture is preferably designed as a thin client in which a dedicated virtual machine running on the game server (or a virtual machine server connected in the gaming network) performs the tasks designated in the present drawing as occurring “at the gaming machine.” In the depicted flowcharts, the method is performed by the respective computer hardware operating under control of computer program code. While central processor arrangements may vary (for example award controllers may be integrated on the same machine with a gaming server, or may be a separate server connected on a secure network), the particular central determinant architecture is not limiting and will be referred to generally in this drawing as the game server (403). To complete the base game and bonus game of FIG. 3 and FIG. 4, the thin client version of the process, performed at the game server, further includes receiving game play requests originating from electronic gaming machine 100, and sending commands to the gaming machine to show reels spinning, the graphical accumulation object, the bonus round selection process, and results being displayed. The division of game logic steps between gaming machines and servers is known in the art and may be accomplished according to suitable methods allowed for the relevant gaming jurisdictions.

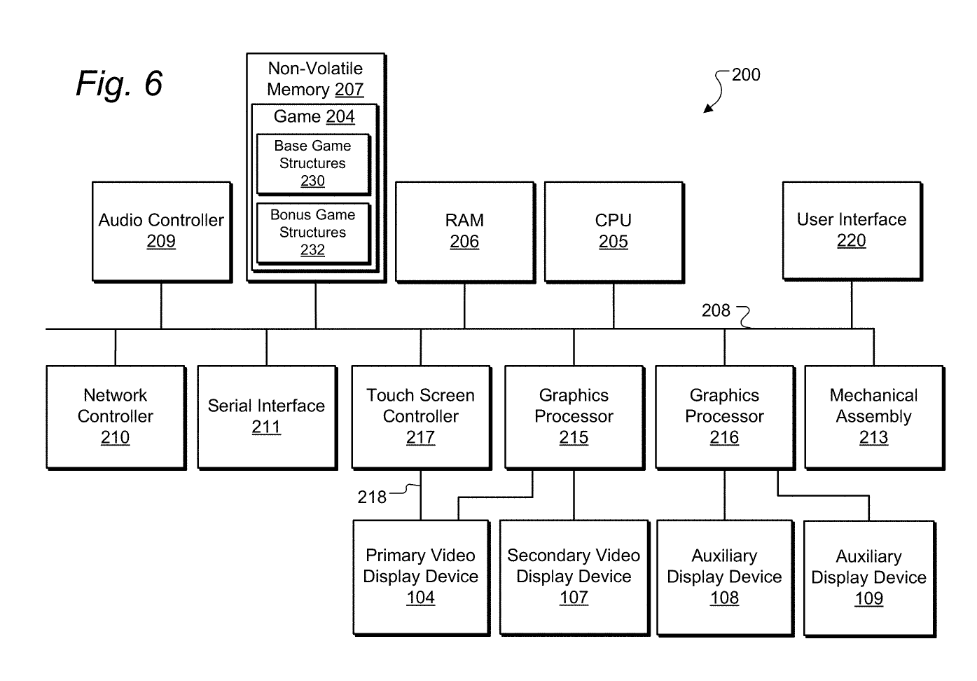

FIG. 5 shows a gaming machine 100 that may be used to implement feature games according to the present invention. The block diagram of FIG. 6 shows further details of gaming machine 100. Referring to FIG. 5, gaming machine 100 includes a cabinet 101 having a front side generally shown at reference numeral 102. A primary video display device 104 is mounted in a central portion of the front surface 102, with a ledge 106 positioned below the primary video display device and projecting forwardly from the plane of the primary video display device. In addition to primary video display device 104, the illustrated gaming machine 100 includes a secondary video display device 107 positioned above the primary video display device. Gaming machine 100 also includes two additional smaller auxiliary display devices, an upper auxiliary display device 108 and a lower auxiliary display device 109. All of the displays may include touchscreen sensors, especially display 109 which may be used to present touchscreen controls for wagering. It should also be noted that each display device referenced herein may include any suitable display device including a cathode ray tube, liquid crystal display, plasma display, LED display, or any other type of display device currently known or that may be developed in the future.

In preferred versions, the gaming machine 100 illustrated in FIG. 5 also includes a number of mechanical control buttons 110 mounted on ledge 106. These control buttons 110 may allow a player to select a bet level, select paylines, select a type of game or game feature, and actually start a play in a primary game. Further, primary video display device 104 in gaming machine 100 provides a convenient display device for implementing touchscreen controls.

Gaming machine 100 may also include a number of other player interface devices in addition to devices that are considered player controls for use in playing a particular game. The ledge may also include a hardware special object including a button, touch sensor, or switches, joysticks, or other mechanical input devices, and/or virtual buttons and other controls implemented on a suitable touchscreen video display. Gaming machine 100 also includes a currency/voucher acceptor having an input ramp 112, a player card reader having a player card input 114, and a voucher/receipt printer having a voucher/receipt output 115. One or more of these devices provides a credit input device in communication with the controller and adapted for accepting a physical item associated with a monetary value that establishes a player credit balance. Audio speakers 116 generate an audio output to enhance the user's playing experience.

FIG. 6 shows a logical and hardware block diagram 200 of gaming machine 100 which includes a central processing unit (CPU) 205 along with random access memory 206 and nonvolatile memory or storage device 207. Storage device 207 is a tangible, nontransitory (nonvolatile) memory holding the program code 204 for presenting the game results as described herein, including a base game data structures 230 containing the data structures associated with the base game round as described above, and bonus game data structures 232 containing the data structures for implementing the bonus game. All of these devices are connected on a system bus 208 with an audio controller 209, a network controller 210, and a serial interface 211. A graphics processor 215 is also connected on bus 208 and is connected to drive primary video display device 104 and secondary video display device 107 (both mounted on cabinet 101 as shown in FIG. 5). A second graphics processor 216 is also connected on bus 208 in this example to drive the auxiliary display devices 108 and 109 also shown in FIG. 5. As shown in FIG. 6, gaming machine 100 also includes a touch screen controller 217 connected to system bus 208. Touch screen controller 217 is also connected via signal path 218 to receive signals from a touchscreen element associated with primary video display device 104. Auxiliary display device 109 may also include an integrated touchscreen controller. It will be appreciated that the touchscreen element itself typically comprises a thin film that is secured over the display surface of primary video display device 104. The touchscreen element itself is not illustrated or referenced separately in the figures.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 6 are elements commonly associated with a computer system architecture. These elements are preferably mounted on a chassis and is itself mounted in cabinet 101 shown in FIG. 5. Alternatively, the various electronic components may be mounted on one or more circuit boards housed within cabinet 101 without a separate enclosure such as those found in personal computers. Those familiar with data processing systems and the various data processing elements shown in FIG. 6 will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 6 as being connected directly on system bus 208 may in fact communicate with the other system components through a suitable expansion bus. Audio controller 209, for example, may be connected to the system via a PCI bus. System bus 208 is shown in FIG. 6 merely to indicate that the various components are connected in some fashion for communication with CPU 205 and is not intended to limit the invention to any particular bus architecture. Numerous other variations in the gaming machine internal structure and system may be used without departing from the principles of the present invention.

It will also be appreciated that graphics processors are also commonly a part of modern computer systems. Although separate graphics processor 215 is shown for controlling primary video display device 104 and secondary video display device 107, and graphics processor 216 is shown for controlling both auxiliary display devices 108 and 109, it will be appreciated that CPU 205 may control all of the display devices directly without any intermediate graphics processor. In some embodiments, the graphical accumulator object 68 (FIG. 1) may be displayed on secondary video display 107 rather than above the matrix of symbol locations, or it may be displayed in another area primary gaming zone on the primary display. The invention is not limited to any particular arrangement of processing devices for controlling the video display device included with gaming machine 100. Also, a gaming machine implementing the present invention is not limited to any particular number of video display devices or other types of display devices.

In the illustrated gaming machine 100, CPU 205 executes software which ultimately controls the entire gaming machine including the receipt of player inputs and the presentation of the graphic symbols displayed according to the invention through the display devices 104, 107, 108, and 109 associated with the gaming machine. As will be discussed further below, CPU 205 either alone or in combination with graphics processor 215 may implement a presentation controller for performing functions associated with a primary game and bonus game that may be available through the gaming machine. CPU 205 also executes software related to communications handled through network controller 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs, while the nonvolatile memory or storage device 207 may comprise a hard drive, flash drive, or other mass storage device providing storage for programs not in use or for other data generated or used in the course of gaming machine operation. Network controller 210 provides an interface to other components of a gaming system in which gaming machine 100 is included.

It should be noted that the invention is not limited to gaming machines employing the computer-type arrangement of processing devices and interfaces shown in example gaming machine 100. Other gaming machines through which the features herein are implemented may include one or more special purpose processing devices to perform the various processing steps for implementing the present invention, such as generating random numbers or checking the security status of software packages or gaming credit vouchers. Unlike general purpose processing devices such as CPU 205, these special purpose processing devices may not employ operational program code to direct the various processing steps.

It should also be noted that the invention is not limited to gaming machines including only video display devices for conveying results. It is possible to implement a feature game within the scope of the present invention using an electro mechanical arrangement or even a purely mechanical arrangement for displaying the symbols or first and second animations or reactions needed to complete the graphical interactions as described herein.

Still referring to the hardware and logical block diagram 200 showing an example design for a gaming machine 100, the depicted machine in operation is controlled generally by CPU 205 which stores operating programs and data in memory 207 with wagering game 204, user interface 220, network controller 210, audio/visual controllers, and reel assembly 213 (if mechanical reel configuration). CPU or game processor 205 may comprise a conventional microprocessor, such as an Intel microprocessor, mounted on a printed circuit board with supporting ports, drivers, memory, software, and firmware to communicate with and control gaming machine operations, such as through the execution of coding stored in memory 207 including one or more wagering games 204. Game processor 205 connects to user interface 220 such that a player may enter input information, and game processor 205 may respond according to its programming, such as to apply a wager and initiate execution of a game. Game processor 205 also may connect through network controller 210 to a gaming network, such as example casino server network 400 shown in FIG. 7.

Referring now to FIG. 7, the casino server network 400 may be implemented over one or more site locations and include host server 401, remote game play server 403 (which may be configured to provide game processor functionality including determining game outcomes and providing audio/visual instructions to a remote gaming device), central determinant server 405 (which may be configured to provide random numbers to gaming processes, or to determine lottery, bingo, or other centrally determined game outcomes and provide the information to networked gaming machines 100 providing lottery and bingo-based wagering games to patrons), progressive server 407 (which may be configured to accumulate a progressive pool from a portion of wagering proceeds or operator marketing funds and to award progressive awards upon the occurrence of a progressive award winning event to one or more networked gaming machines 100), player account server 409 (which may be configured to collect and store player information and/or awards and to provide player information to gaming machines 100 after receiving player identification information such as from a player card), and accounting server 411 (which may be configured to receive and store data from networked gaming machines 100 and to use the data to provide reports and analyses to an operator). Through its network connection, gaming machine 100 may be monitored by an operator through one or more servers such as to assure proper operation, and, data and information may be shared between gaming machine 100 and respective of the servers in the network such as to accumulate or provide player promotional value, to provide server-based games, or to pay server-based awards. As depicted in FIG. 7, a block diagram of an example networked gaming system 400 may be associated with one or more gaming facilities, including one or more networked gaming machines 100 in accordance with various embodiments. With reference to FIG. 7, while a few servers have been shown separately, they may be combined or split into additional servers having additional capabilities.

As shown, networked gaming machines 100 (EGM1-EGM4) and one or more overhead displays 413 may be network connected and enable the content of one or more displays of gaming machines 100 to be mirrored or replayed on an overhead display, or a graphic and audio sequence is shown for announcing and celebrating that a large value win has occurred, known as “celebration” sequence. For example, the primary display content may be stored by the display controller or game processor 205 and transmitted through network controller 210 to the overhead display controller either substantially simultaneously or at a subsequent time according to either periodic programming executed by game processor 205 or a triggering event, such as a jackpot or large win, at a respective gaming machine 100. In the event that gaming machines 100 have cameras installed, the respective player's video images may be displayed on overhead display 413 along with the content of the player's gaming machine 100 and any associated audio feed.

In one or more embodiments, game server 403 may provide server-based games and/or game services to network connected gaming devices, such as gaming machines 100 (which may be connected by network cable or wirelessly). Progressive server 407 may accumulate progressive awards by receiving defined amounts (such as a percentage of the wagers from eligible gaming devices or by receiving funding from marketing or casino funds) and provide progressive awards to winning gaming devices upon a progressive event, such as a progressive jackpot game outcome or other triggering event such as a random or pseudo-random win determination at a networked gaming device or server (such as to provide a large potential award to players playing the community feature game). Accounting server 411 may receive gaming data from each of the networked gaming devices, perform audit functions, and provide data for analysis programs, such as the IGT Mariposa program bundle.

Player account server 409 may maintain player account records, and store persistent player data such as accumulated player points and/or player preferences (e.g. game personalizing selections or options). For example, the player tracking display may be programmed to display a player menu that may include a choice of personalized gaming selections that may be applied to a gaming machine 100 being played by the player.

In one or more embodiments, the player menu may be programmed to display after a player inserts a player card into the card reader. When the card reader is inserted, an identification may be read from the card and transmitted to player account server 409. In some systems, the player card constitutes a physical object which may be read by the gaming machine 100 to deposit credits to the gaming machine for playing, although typically such credits are provided through currency or credit vouchers. Player account server 409 transmits player information through network controller 210 to user interface 220 for display on the player tracking display. The player tracking display may provide a personalized welcome to the player, the player's current player points, and any additional personalized data. If the player has not previously made a selection, then this information may or may not be displayed. Once the player makes a personalizing selection, the information may be transmitted to game processor 205 for storing and use during the player's game play. Also, the player's selection may be transmitted to player account server 409 where it may be stored in association with the player's account for transmission to the player in future gaming sessions. The player may change selections at any time using the player tracking display (which may be touch sensitive or have player-selectable buttons associated with the various display selections).

In one or more embodiments, a gaming website may be accessible by players, e.g. gaming website 421, whereon one or more games may be displayed as described herein and played by a player such as through the use of personal computer 423 or handheld wireless device 425 (e.g. Apple iPhone, Android phone, tablet, phablet, virtual reality device, iPad, etc.). To enter the website, a player may log in with a username (that may be associated with the player's account information stored on player account server 409 or be accessible by a casino operator to obtain player data and provide promotional offers), play various games on the website, make various personalizing selections and save the information, so that during a next gaming session at a casino establishment, the player's playing data and personalized information may be associated with the player's account and accessible at the player's selected gaming machine 100.

Referring generally to the description herein, any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

Further, as described herein, the various features have been provided in the context of various described embodiments, but may be used in other embodiments. The combinations of features described herein should not be interpreted to be limiting, and the features herein may be used in any working combination or sub-combination according to the invention. This description should therefore be interpreted as providing written support, under U.S. patent law and any relevant foreign patent laws, for any working combination or some sub-combination of the features herein.

The above described preferred embodiments are intended to illustrate the principles of the invention, but not to limit the scope of the invention. Various other embodiments and modifications to these preferred embodiments may be made by those skilled in the art without departing from the scope of the present invention.

1. A gaming machine comprising:
a cabinet to which is mounted one or more video displays;
a controller operatively coupled to control the one or more video displays;
a credit input device in communication with the controller and adapted for accepting a physical item associated with a monetary value that establishes a player credit balance;
a plurality of player-activated input devices in communication with the controller for setting wagers covered by the credit balance and initiating games for determining the outcomes of the wagers;
a first data structure stored in a memory comprising data corresponding to a reel-type game presentations including a set of virtual reel strips including game symbols;
a second data structure stored in memory comprising data representing a set player interactive bonus objects;
a third data structure stored in memory comprising data representing graphical indicators of progressive prize awards;
wherein the controller is programmed to:
activate the first data structure to cause the game presentation data to be displayed by at least one of the displays;
in response to a wager activation by a player on one of the player input devices, cause the game presentation to display conducting a base game including spinning the sets of virtual reel strips and stopping to produce a respective randomly selected outcome, and evaluate the outcomes for winning patterns each having an associated credit award;
determine if a bonus trigger occurs in the outcome, and if so, activate the second data structure and the third data structure to display the conduct of a bonus game and a bonus game result, comprising:
(a) displaying the graphical indicators of progressive prize awards;
(b) displaying the group of player interactive bonus objects in a gaming area of the display below the graphical indicators;
(c) receiving repeated player selection of the player interactive objects to reveal progressive prize symbols which persist on the gaming area between player selections;
(d) determining if three matching progressive prize symbols have been revealed, and if so awarding a corresponding progressive prize;
(e) determining if a designated progressive eliminator symbol has been revealed, and if so a graphical interaction between an element in the gaming area of the display and the graphical indicators, the graphical interaction including showing a lowest value graphical indicator being removed from availability; and
receive a player cash out input through the player controls and, in response, initiate a payout of the credit balance.

2. The gaming machine of claim 1, in which the graphical interaction between the element in the gaming area and the graphical indicators is to show a flame passing from the element to the lowest value indicator, having the effect of showing the lowest value indicator as being burned and partially turned to ashes but still being displayed when removed from availability.

3. The gaming machine of claim 1, further comprising a fourth a data structure stored in the memory comprising data corresponding to a graphical accumulator object, the fourth data structure having a persistent state across multiple base game rounds, and wherein the controller is further programmed to: determine if a designated symbol is present when evaluating each base game outcome, and if so cause a graphical interaction to be displayed between the designated symbol and the graphical accumulator object, increasing an accumulation level of the object; and if the accumulation level of the object fills, activate the bonus trigger.

4. The gaming machine of claim 1, in which the graphical interaction is displayed between progressive eliminator symbol and a selected graphical indicator.

5. The gaming machine of claim 1, in which the graphical interaction is displayed between an animated character in the gaming area and a selected graphical indicator.

6. The gaming machine of claim 1, in which the graphical interaction is shown to cross between a primary display of the displays and a secondary display of the displays.

7. A method of providing a wagering game under control of a gaming machine electronic controller, the method comprising:
providing a first data structure stored in a memory of the gaming machine comprising data corresponding to a reel-type game presentations including a set of virtual reel strips including game symbols;
providing a second data structure stored in the memory comprising data representing a set player interactive bonus objects;
providing a third data structure stored in the memory comprising data representing graphical indicators of progressive prize awards; receiving a player deposit through a credit input device and in response activating a credit meter value that establishes a player credit balance;
activate the first data structure to cause the game presentation to be displayed by at least one of the displays;
in response to a wager activation by a player on one of the player input devices, cause the game presentation to display conducting a base game including spinning the sets of virtual reel strips and stopping to produce a respective randomly selected outcome, and evaluate the outcomes for winning patterns each having an associated credit award;
determine if a bonus trigger occurs in the outcome, and if so, activate the second data structure and the third data structure to display the conduct of a bonus game and a bonus game result, comprising:
(a) displaying the graphical indicators of progressive prize awards;
(b) displaying the group of player interactive bonus objects in a gaming area of the display below the graphical indicators;
(c) receiving repeated player selection of the player interactive objects to reveal progressive prize symbols which persist on the gaming area between player selections;
(d) determining if three matching progressive prize symbols have been revealed, and if so awarding a corresponding progressive prize;
(e) determining if a designated progressive eliminator symbol has been revealed, and if so displaying a graphical interaction between an element in the gaming area of the display and the graphical indicators, the graphical interaction including showing a lowest value graphical indicator being removed from availability; and
receive a player cash out input through the player controls and, in response, initiate a payout of the credit balance.

8. The method of claim 7, in which the graphical interaction between the element in the gaming area and the graphical indicators is to show a flame passing from the element to the lowest value indicator, having the effect of showing the lowest value indicator as being burned and partially turned to ashes but still being displayed when removed from availability.

9. The method of claim 7, further comprising:
providing a fourth a data structure stored in the memory comprising data corresponding to a graphical accumulator object, the fourth data structure having a persistent state across multiple base game rounds;
determining if a designated symbol is present when evaluating each base game outcome, and if so cause a graphical interaction to be displayed between the designated symbol and the graphical accumulator object, increasing an accumulation level of the object; and
if the accumulation level of the object fills, activate the bonus trigger.

10. The method of claim 7, in which the graphical interaction is displayed between progressive eliminator symbol and a selected graphical indicator.

11. The method of claim 7, in which the graphical interaction is displayed between an animated character in the gaming area and a selected graphical indicator.

12. The method of claim 7, in which the graphical interaction is shown to cross between a primary display of the displays and a secondary display of the displays.

13. A tangible, non-transitory computer readable medium holding a program product for execution by a controller of a gaming machine having one or more video displays, the program product including machine instructions for:
operating a credit input device in communication with the controller to accept a physical item associated with a monetary value and, in response, establishing a player credit balance;
controlling a plurality of player-activated input devices in communication with the controller for setting wagers covered by the credit balance and initiating games for determining the outcomes of the wagers;
providing a first data structure stored in a memory comprising data corresponding to a reel-type game presentations including a set of virtual reel strips including game symbols;
providing a second data structure stored in memory comprising data representing a set player interactive bonus objects;
providing a third data structure stored in memory comprising data representing graphical indicators of progressive prize awards;
activating the first data structure to cause the game presentation data to be displayed by at least one of the displays;
in response to a wager activation by a player on one of the player input devices, causing the game presentation to display conducting a base game including spinning the sets of virtual reel strips and stopping to produce a respective randomly selected outcome, and evaluate the outcomes for winning patterns each having an associated credit award;
determining if a bonus trigger occurs in the outcome, and if so, activate the second data structure and the third data structure to display the conduct of a bonus game and a bonus game result, comprising:
(a) displaying the graphical indicators of progressive prize awards;
(b) displaying the group of player interactive bonus objects in a gaming area of the display below the graphical indicators;
(c) receiving repeated player selection of the player interactive objects to reveal progressive prize symbols which persist on the gaming area between player selections;
(d) determining if three matching progressive prize symbols have been revealed, and if so awarding a corresponding progressive prize;
(e) determining if a designated progressive eliminator symbol has been revealed, and if so a graphical interaction between an element in the gaming area of the display and the graphical indicators, the graphical interaction including showing a lowest value graphical indicator being removed from availability; and
receiving a player cash out input through the player controls and, in response, initiate a payout of the credit balance.

14. The program product of claim 13, in which the graphical interaction between the element in the gaming area and the graphical indicators is to show a flame passing from the element to the lowest value indicator, having the effect of showing the lowest value indicator as being burned and partially turned to ashes but still being displayed when removed from availability.

15. The program product of claim 13, further comprising a fourth a data structure stored in the memory comprising data corresponding to a graphical accumulator object, the fourth data structure having a persistent state across multiple base game rounds, and wherein the controller is further programmed to: determine if a designated symbol is present when evaluating each base game outcome, and if so cause a graphical interaction to be displayed between the designated symbol and the graphical accumulator object, increasing an accumulation level of the object; and if the accumulation level of the object fills, activate the bonus trigger.

16. The program product of claim 13, in which the graphical interaction is displayed between progressive eliminator symbol and a selected graphical indicator.

17. The program product of claim 13, in which the graphical interaction is displayed between an animated character in the gaming area and a selected graphical indicator.

18. The program product of claim 13, in which the graphical interaction is shown to cross between a primary display of the displays and a secondary display of the displays.
